(19) United States
(12) Patent Application Publication
(10) Pub. No.: US 2003/0075599 A1
(43) Pub. Date: Apr. 24, 2003

(54) Personal work environment setting method

(76) Inventors: Hiroaki Takatsuki, Suginami-ku (JP); Takashi Yoshimaru, Kokubunji-shi (JP); Nobuhiko Matsukuma, Hitachi-shi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/286,910

(22) Filed: Nov. 4, 2002

Related U.S. Application Data
(63) Continuation of application No. 09/195,705, filed on Nov. 19, 1998, now abandoned.

(30) Foreign Application Priority Data
Nov. 20, 1997 (JP) 9-319748

(51) Int. Cl. G06K 5/00

(52) U.S. Cl. 235/380

(57) ABSTRACT

A personal work environment of a personal computer (PC) can be automatically set based on information stored in an IC card and information stored in a server. Personal authentication information of an individual who performs some work by using the PC is stored in the IC card and sets of the personal authentication information of the user, AP (application) related information, a data file, OS (operating system), and an AP are stored in the server in correspondence to an individual. When the user sets the IC card into the PC, the PC automatically starts up, reads out the personal authentication information in the IC card, downloads information necessary to start the work from the server, and automatically reproduces the work environment at the time when the user interrupted the previous work on the basis of environment information at the end of the previous work included in the above information.

The present application is a continuation of application Ser. No. 09/195,705, filed Nov. 19, 1998, the contents of which are incorporated herein by reference.

### BACKGROUND OF THE INVENTION

The present invention relates to a personal work environment setting method using an IC card at the time of start-up of a personal computer (hereinbelow, simply called a PC). More particularly, the invention relates to a personal work environment setting method using an IC card such that, in a PC which is connected to a network, when work is performed using the PC or another PC and the work is interrupted prior to completion, a work environment at the time of interruption can be automatically set at the next start-up of the PC.

Work using a PC according to a conventional technique is generally performed after starting up the PC, activating a necessary application program, and reading a data file necessary for the work. At the end of the work, even if the work is partially completed, processes such as registering in a file data generated up to the time of ending the work and closing of the application program have to be carried out.

As mentioned above, performing work using a PC according to the conventional technique requires that a number of procedures from the start of the work until the end of the work be performed. Performing these procedures are in inconvenient and tedious. There is consequently a problem that the result of the work registered at the end of the work and the laborious work is lost.

When the user intends to continue the work by using a different PC in another office, location, or the like, there is another problem that the PC in the other office, location, or the like is not easily used since the set environment is different. As a solution to such a problem, although one can always carry a portable PC, the risk of failure, loss, or the like of the portable PC is high and it is not easy to carry the portable PC since it is not light. Moreover, the portable PC does not solve the above-described complicatedness of the procedures at the time of both the start-up and ending.

As a conventional technique which can set a personal use environment, for example, as it is seen in an operating system (OS) used in a workstation or the like, a technique of opening windows of a plurality of user accounts on a single screen, thereby enabling a work in the environment corresponding to the user to be performed is known. The technique, however, does not solve the problem since the user environment has to be switched by inputting a command from a keyboard and no function of displaying which user environment can be used is provided.

### SUMMARY OF THE INVENTION

It is an object of the invention to solve the problem of the conventional technique and to provide a personal work environment setting method using an IC card such that, in a PC used by being connected to a network, when work is performed by using the PC or another PC and is interrupted prior to completion, the work environment at the time of interruption can be automatically set at the next start-up of the PC.

According to the invention, the object is achieved by a personal work environment setting method of a personal computer in a network system in which a server and a personal computer are connected. The personal computer has an IC card reader/writer. When an IC card is set into the IC card reader/writer, information including personal authentication information stored in the IC card and personal authentication information stored in the server, are used to determine a work environment to be set in the personal computer. The work environment determined to be set in the personal computer is then set in the personal computer. When the IC card is set into the IC card reader/writer, the personal computer is automatically started or is controlled to be active. When the IC card is ejected, information regarding the work environment at that time is stored into the server or the IC card.

The object is also achieved in such a manner that personal authentication information, an OS, an AP (application), OS related information, AP related information, and a data file set as the information stored in the server and work environment information at the time of ending or interruption of the previous work is included in the information. It is also achieved in such a manner that only personal authentication information is set as information stored in the server, the OS, AP, OS related information, AP related information, and data file are stored in addition to the personal authentication information in the IC card, and the work environment information at the time of ending or interruption of the previous work is included in the information.

Further, the object is achieved by storing the personal authentication information both in a server and an IC card and properly dispersing and storing the OS, AP, OS related information, AP related information, and data file into the server, the personal computer, and the IC card.

### BRIEF DESCRIPTION OF THE DRAWINGS

FIG. 1 is a block diagram showing the structure of a PC to which an embodiment of the invention is applied;

FIG. 2 is a block diagram showing an example of the structure of a network system in which the PC shown in FIG. 1 is used;

FIG. 3 is a diagram for explaining information held by each of a server, a PC, and an IC card;

FIG. 4 is a flowchart for explaining the operation of the embodiment of the invention;

FIG. 5 is a flowchart for explaining the details of a processing operation for acquiring card authentication information in FIG. 4;

FIG. 6 is a diagram showing an example of a display screen of the PC when a personal work environment can be selectively switched;

FIG. 7 is a diagram for explaining another example of information held by each of the server, the PC, and the IC card;

FIG. 8 is a diagram for explaining another example of information held by each of the server, the PC, and the IC card;

FIG. 9 is a diagram for explaining another example of information held by each of the server, the PC, and the IC card;

FIG. 10 is a diagram for explaining another example of information held by each of the server, the PC, and the IC card; and

FIG. 11 is a diagram for explaining another example of information held by each of the server, the PC, and the IC card.

### DESCRIPTION OF THE PREFERRED EMBODIMENTS

An embodiment of a personal work environment setting method according to the invention will be described in detail hereinbelow with reference to the drawings.

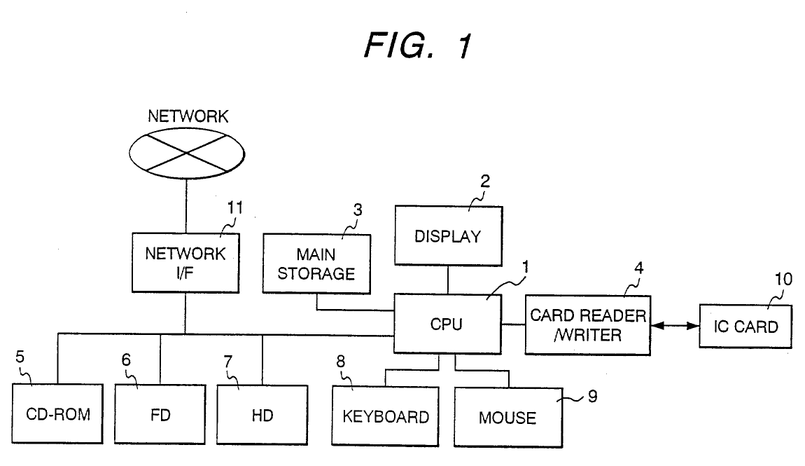

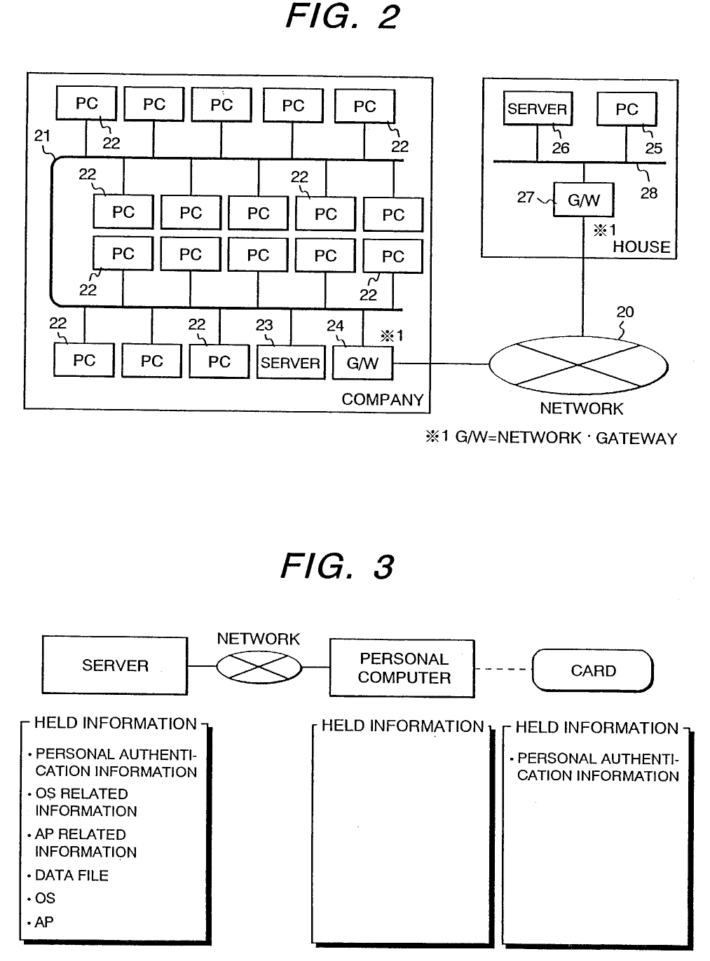

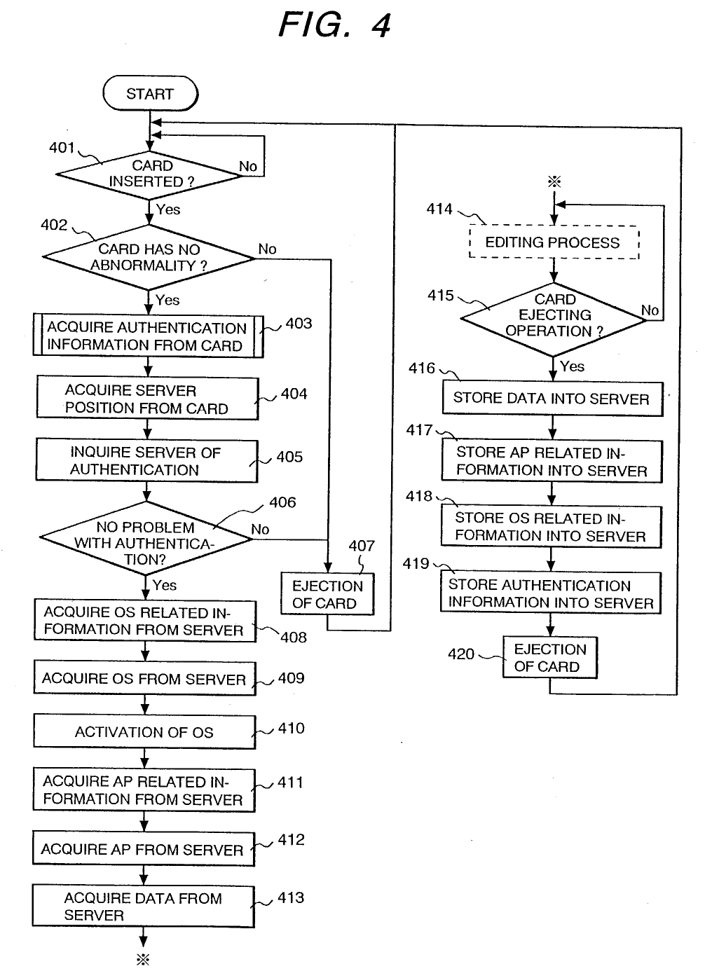

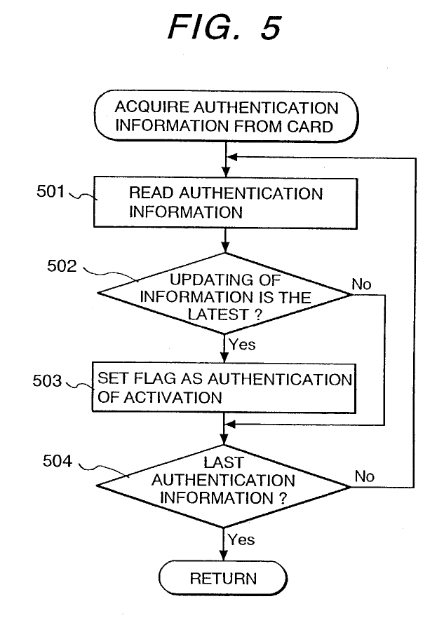

FIG. 1 is a block diagram showing the structure of a PC to which an embodiment of the invention is applied. FIG. 2 is a block diagram showing an example of the structure of a network system in which the PC shown in FIG. 1 is used. FIG. 3 is a diagram for explaining information held by each of a server, a PC, and an IC card. FIG. 4 is a flowchart for explaining the operation of the embodiment of the invention. FIG. 5 is a flowchart for explaining the details of a processing operation for acquiring card authentication information in FIG. 4. In FIGS. 1 to 3, reference numeral 1 denotes a CPU; 2 a display; 3 a main storage; 4 a card reader/writer; 5 a CD-ROM disk drive; 6 an FD disk drive; 7 an HD drive; 8 a keyboard; 9 a mouse; 10 an IC card; 11 a network interface; 20 a network; 21 an inhouse network; 22 and 25 PC5; 23 and 26 servers; and 24 and 27 G/Ws (network gateways).

A PC to which an embodiment of the invention is applied can take any form which are or becomes known to those skilled in the art. For example, as shown in FIG. 1, the PC includes the CPU 1; the display 2 constructed by a CRT, a liquid crystal, or the like; the main storage 3; the card reader/writer 4; the CD-ROM disk drive 5; a device such as the FD disk drive 6 for reading and writing data from/to an external storage medium; the HID drive 7 as an internal secondary storage; input devices such as the keyboard 8 and the mouse 9; the IC card 10 in which information described hereinlater is stored; and the network interface 11 for controlling a communication with a network. The PC could include all or some of the elements described above as would be known to those skilled in the art.

The PC constructed as mentioned above is included in a network system shown as an example in FIG. 2 and is used. In the example shown in FIG. 2, a company and a house of the individual user are connected via the network 20 such as a public communication network. A PC and a server 26 which are used by the individual are provided in his/her house. A number of PCs 22 and a server 23 which are used by employees are provided in the company. The PC 25 and the server 26 in his/her house are connected via a network 28 such as LAN. The number of PCs 22 and the server 23 in the company are connected to the network 21 such as an inhouse LAN. Further, the network 28 in his/her house and the external network 20 are connected via the G/W 27 and the network 21 in the company and the external network 20 are connected via the G/W 24.

According to one embodiment of the invention, the personal work environment of the PC to be used by the user can be automatically set on the basis of information stored in the IC card 10 and information stored in the server 23 or 26. In order to realize it, in the embodiment of the invention, information as shown in FIG. 3 is stored in the IC card 10 and the server 23 or 26.

In the example of FIG. 3, only personal authentication information of the individual for performing some work by using the PC 22 or 25 is stored in the IC card 10. A number of information sets corresponding to individuals are stored in the server 23 or 26. The information set includes personal authentication information of the user; OS related information used for operations such as selection from a plurality of different operating systems (OSs) and reproduction of a work environment of the OS at the end of the previous work; AP related information used for operations such as selection from a plurality of different application programs (APs) and reproduction of a work environment of the AP at the end of the previous work; a data file including work state information at the end of the previous work; one or a plurality kinds of OSs; and a number of AP5.

In the above description, with respect to the OSs and APs in the information sets corresponding to individuals provided for the server, it is unnecessary that the OSs and AP5 themselves are provided. Only authentication information such as names of the OSs and APs permitted to be used by the individual is sufficient. The OS and AP can be commonly provided for a number of individual users. In the example shown in FIG. 3, it is unnecessary to store any information in the PC. The IC card 10 includes a non-volatile memory such as EEPROM which can electrically write or erase data.

The user who is going to perform a work by using the PC 22 or 25 connected in the network system shown in FIG. 2 sets his/her IC card 10 into the slot of the card reader/writer 4 of the PC. By this operation, the PC automatically starts up. The CPU 1 in the PC reads out the personal authentication information in the IC card 10, executes communication with the server 23 or 26, and automatically downloads OS, AP, information related to the OS and AP, and a data file necessary to start the work into the main storage 3 in the PC and, according to necessity, into the HD drive 7 on the basis of the information in the information set of the corresponding individual.

The CPU 1 automatically sets the work environment at the time point when the user interrupted the previous work on the basis of the downloaded information and allows the display 2 to display the state at the time of the previous work interruption. When the user tries to eject the IC card 10 from the card reader/writer 9 to interrupt the work, the CPU 1 saves all of information in the state at this time of interruption to the server by completion of the ejection of the IC card 10 and finishes the process.

When the card reader/writer 4 does not have an automatic loading/unloading mechanism and the user inserts or ejects the card, it is sufficient to detect ejection of the IC card by setting one of contacts pins provided on the card side to come off from the connector side quicker than the other pins, and to perform an ending process as mentioned above by the end of the ejection of the other pins.

The construction of the embodiment of the invention and the outline of the operation has been described above. The operation of the embodiment of the invention will now be described in detail with reference to the flowcharts of FIGS. 4 and 5.

(1) The card reader/writer 4 detects insertion of the IC card 10, makes only the card reader/writer 4 itself operative, and detects the presence or absence of a physical abnormality in size, standard, or the like of the inserted IC card 10. When there is an abnormality, the IC card 10 is ejected. In this case, the card reader/writer 4 is provided with the automatic loading/unloading mechanism and it is sufficient to set that the card reader/writer 4 is made operative by a pushing force of the card when the IC card 10 is inserted (steps 401, 402, and 407).

(2) The card reader/writer 4 detects, the presence or absence of the physical abnormality such as size and standard of the inserted IC card 10. When no abnormality is detected, the power source for the whole PC is turned on. When the PC is in a “sleep” state, the PC is made active at this time point. When the PC is started or made active, the card reader/writer 4 records that time as a log-in time or the like into the IC card 10. The CPU 1 in the PC obtains the personal authentication information from the IC card 10 via the card reader/writer 4 and acquires server position information (authentication information such as a server address). In this instance, it can be also arranged to let the user input a password (steps 403 and 404).

(3) The CPU 1 executes a communication with the server via the network interface 11 and the networks in the company and the house on the basis of the acquired server position information. Whether the personal authentication information is correct or illegal and whether the password is correct or not in the case where it is inputted to the server are inquired to the server. If there is a problem with the authentication information or password, the CPU 1 instructs the card reader/writer 4 to eject the IC card 10 (steps 405 to 407).

(4) When there is no problem with the personal authentication information in the check at step 406, the CPU 1 acquires the OS related information and the OS from the information set provided in the server in correspondence to the personal authentication information and activates the OS. After that, the CPU 1 acquires the AP related information and the AP from the server, activates the AP, and obtain data in the data file. The CPU 1 consequently reproduces the position of an icon, and the size, position, clipboard and the like of a window at the end of previous work and reproduces a display picture at the end of previous work. The position of the icon and the size, position, clip-board, and the like of the window at the end of the previous work can be also stored as information related to the OS or AP in the server or can be stored as auxiliary data of the work data in the server (steps 408 to 413).

(5) By the above processes, the environment at the end of the previous work stored in the server is reproduced in correspondence to the personal authentication information stored in the IC card 10 held by the user, and the user can perform a work such as an editing process subsequent to the previous work (step 414).

(6) The CPU 1 monitors whether the operation for ejecting the IC card 10 is carried out or not while the user executes a process for the work at step 414. When the user executes an operation for ejecting the IC card, for example, when the user operates an ejection instruction button or the like provided for the card reader/writer 4, the CPU 1 executes a process for detecting the operation, determining it as an interruption of the work, storing the data processed halfway into the server, and storing the AP related information, the OS related information, and the personal authentication information into the server. In this instance, the CPU 1 simultaneously stores the position and size of the window, the position of an icon, and the like into the server. Further, the CPU 1 makes the card reader/writer 4 eject the IC card 10 after completion of the above processes. The card reader/writer 4 records the ejection time as a log-out time into the IC card 10 (steps 415 to 420).

The operation of a process for obtaining the personal authentication information at step 403 will now be described in more details with reference to FIG. 5.

(1) When the personal authentication information from the CPU 1 is received, the server checks whether the same personal authentication information is registered or not in the server itself. If YES, the personal authentication information is read out and whether the previous log-out time recorded in the IC card 10 coincides with that recorded in the self apparatus or not, namely, whether updating of information is the latest or not is checked (steps 501 and 502).

(2) When the updating of information is determined to be the latest by the check at step 502, the server sets a flag indicative of authentication of activation of the information set including the OS related information, AP related information, OS, AP, and the like stored in the self apparatus in correspondence to the personal authentication information (step 503).

(3) After completion of the process at step 503 and when it is determined by the check at step 502 that the updating of information is not the latest, whether the personal authentication information is the last authentication information or not is checked. If YES, the process is finished. If NO, the processing routine is returned to the process at step 501 and the next personal authentication information is read out. A case where there are a plurality of personal authentication information will be described hereinlater (step 504).

According to the foregoing embodiment of the invention, the above-mentioned operations described with reference to FIGS. 4 and 5 are executed to register the personal authentication information including the log-out time at the end of the previous work into the IC card 10. Only by setting the IC card into the PC, the state information (OS, AP, information related to the OS and AP, and work data) of the work interrupted in the previous work can be downloaded from the server, and the state can be reproduced in the PC. Consequently, only by setting the IC card 10 into the PC, the user can continue the work from the state interrupted at the previous time.

According to the foregoing embodiment of the invention, only by the instruction of ejection of the IC card 10 by the user without performing a special ending process at the time of interruption, the work environment such as the data being processed, the position of the icon, the position and size of the window, and the like are stored in the server. Consequently, cases such that the work data is forgotten to be stored can be prevented.

The above-mentioned embodiment of the invention has been described on the assumption that the number of personal authentication information stored in the IC card is basically one. When the PC is used in a network system environment as shown in FIG. 2, however, there are the following states for performing different works; a state in which an individual makes a personal work by using the PC 25 in his/her house and using the information set of the personal authentication information, the OS and AP corresponding to the information, information related to the OS and AS, the work data, and the like stored in the server 26 in his/her house; a state in which an individual performs a work as a company work by using the PC 22 in his/her house and using the information set of the personal authentication information, the OS and AP corresponding to the personal authentication information, information related to the OS and AP, work data, and the like; a state in which an individual performs a work as a company duty by using the PC 22 in the company and using a set of information of the personal authentication information, the OS and AP corresponding to the personal authentication information, information related to the OS and AP, work data, and the like stored in the server 23 in the company.

In case of performing the works of different characters, it is necessary to make a specific server unaccessible in accordance with a PC to be used, for example, it is necessary to make the access to the server in the house impossible in order to inhibit the work using the information set corresponding to the personal authentication information in the server 26 in the house by using the PC in the company. In case of using the PC for a duty in a company as well, it is desirable to allocate respective work environments necessary for performing works for duties related to different posts, projects or the like to an individual. For such a case, according to the invention, it is possible to provide a plurality of personal authentication information for each individual and register the information in the IC card of the individual.

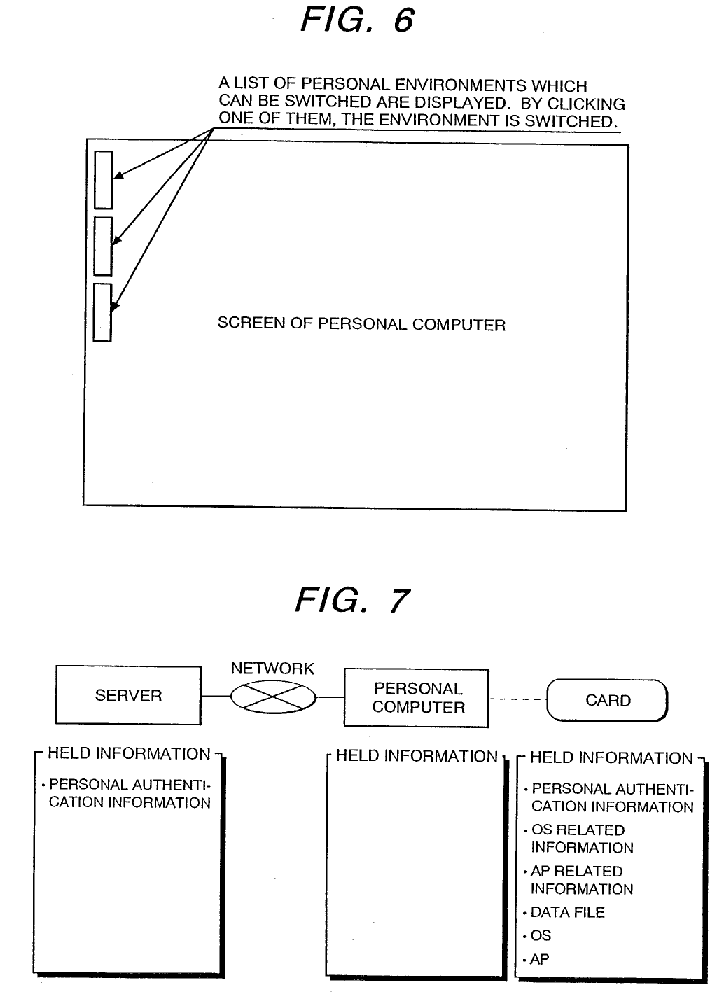

FIG. 6 is a diagram showing an example of the display screen of the PC when the personal work environments can be selectively switched, in which a plurality of personal authentication information is provided in the IC card 10 which is held by the individual, the corresponding personal work environment is selectively switched, and an access to a specific server is inhibited.

When the IC card in which a plurality of personal authentication information is stored is set into the card reader/writer 4 and the PC is activated, the CPU 1 in the PC obtains the plurality of personal authentication information from the IC card 10 via the card reader/writer 4 in the processes at steps 403 and 404 described with reference to FIG. 4 and also acquires the server position information (authentication information such as the server address). The CPU 1 displays a list of names or the like of the personal environments corresponding to the personal authentication information having the server position information by which an access can be realized from the self apparatus on the display screen. When the user selects one of the displayed names or the like of the personal environments, the CPU 1 performs the above-mentioned process with the server by using the corresponding personal authentication information and reproduces the previous work environment corresponding to the personal authentication information in the PC.

As described above, according to the embodiment of the invention, by providing a plurality of personal authentication information in the IC card 10 which is held by the individual, the personal work environment corresponding to the personal authentication information can be selectively switched and the access to a specific server can be inhibited.

Although a key displayed on the display screen is clicked by the mouse for an instruction as a means for switching the environment in the foregoing embodiment, a button can be also provided on the monitor or for the keyboard in a hardware manner. Consequently, it can be discriminated from other icons displayed on the display screen, so that an erroneous operation for erroneously switching the operation environment during a work can be reduced. Further, it is also effective to provide the hard key with an LED or the like showing whether it can be connected or not at present. If there is a small liquid crystal display showing the server name instead of the LED, the state can be grasped more accurately and it is effective when the greater number of work environments are switched.

The foregoing embodiment of the invention has been described as follows. One or a plurality of personal authentication information is provided in the IC card 10 and the information for reproducing the previous work environment using the personal authentication information is held in the server. According to the invention, contrarily, it is also possible to store only the personal authentication information in the server and to store all of the information for setting the personal work environment in the IC card 10.

FIG. 7 is a diagram for explaining the information held by each of the server, the PC, and the IC card in the case where only the personal authentication information is held in the server and all of the information for setting the personal work environment is held in the IC card.

In the example shown in FIG. 7, only the personal authentication information of the individual for performing some work by using the PC 22 or 25 is stored in the server 23 or 26. In the IC card 10, information sets are stored in correspondence to a plurality of personal authentication information. Each of the information sets comprises: the personal authentication information of the user; the OS related information as information to be used for operations such as selection from a plurality of different OSs and setting of the work environment of the OS; the AP related information as information to be used for operations such as selection from a plurality of different APs and setting of the work environment of the AP; a data file including the work environment information; one or a plurality kinds of OSs; and a number of APs.

In the above example, it is unnecessary to store any information in the PC. The IC card 10 is constructed by comprising a non-volatile memory such as an EEPROM to/from which data can be electrically written/erased. It is also possible that the IC card 10 is made correspond to each of the personal authentication information and is held by the user.

The operation when the above-mentioned IC card 10 is inserted into the card reader/writer 4 of the PC is different from that of the foregoing case with respect to a point such that the server confirms the personal authentication information and permits use of the resources of a printer or the like provided for the server and the personal work environment can be set only by the PC and the IC card 10. That is, in this case, the CPU 1 in the PC can read the information of the state at the end of the previous work necessary to set the personal work environment from the IC card 10, activate the OS and AP, and acquire the work data. When the work is finished or interrupted, all of the information regarding the work environment can be stored into the IC card 10. According to the example, the CPU 1 can use the storing function in the IC card 10 as the main storage of the self unit. By employing the using method, when an access control unit is provided in the PC, the main storage 3 is made unnecessary. Although the example shown in FIG. 7 has an advantage such that the user can carry all of the work environment information regarding his/her work, it also has a problem that not only the work environment but also the data file being processed are lost when the IC card is lost or broken. In the example described with reference to FIG. 3, a time for downloading various information from the server to the PC is necessary and it takes some time to start the PC. In the example described with reference to FIG. 7, it is unnecessary to download the information from the server so that the PC can be started up more quickly by such an amount. Especially, when the memory in the IC card 10 is used as the main storage of the PC, the PC can be started up extremely at high speed and the work can be started.

The embodiments of the invention relate to the example in which one or a plurality of personal authentication information is provided in the IC card 10 and the information for reproducing the environment of the previous work performed by using the personal authentication information is held in the server, and the example in which only the personal authentication information is held in the server and all of the information for setting the personal work environment is held in the IC card 10. The invention can be also embodied in such a manner that the personal authentication information is basically provided for the IC card and the server and other information for setting the work environment, that is, the OS related information, AP related information, OS, AP, and data file is properly dispersed and provided for the server, PC, and IC card. Such examples will be described hereinbelow.

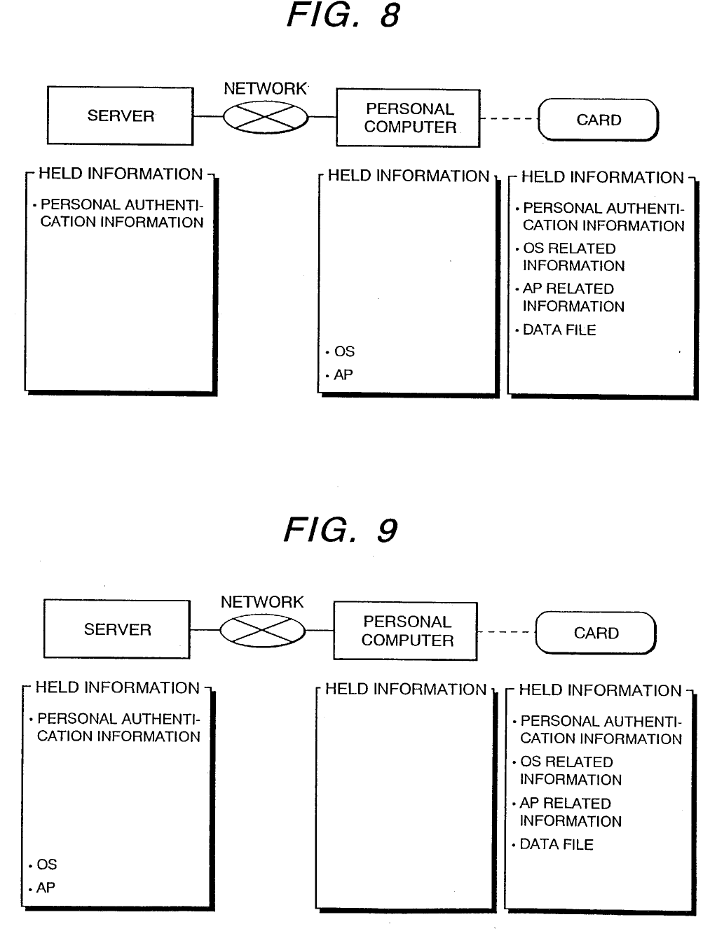

FIGS. 8 to 11 are diagrams showing examples where the information for setting the work environment is dispersedly held in the server, the PC, and the IC card. The examples have intermediate characters between the example explained with reference to FIG. 3 and the example explained with reference to FIG. 7.

In the example shown in FIG. 8, the OS and the AP are held in the PC and the OS related information, the AP related information, and the data file are held in the IC card 10. Although the example has an advantage that variation in the hardware can be absorbed at the OS level, there is a risk of loosing the data file. According to the example, the AP which can process the data file in the IC card has to exist on the PC. In the example shown in FIG. 9, the OS and the AP are held in the server, and the OS related information, the AP related information, and the data file are held in the IC card 10. Although the example has an advantage that there is no need to install the AP in the PC in contrast with the case of FIG. 8, there is a problem that it takes time to set the work environment since the OS and the AP are downloaded from the server.

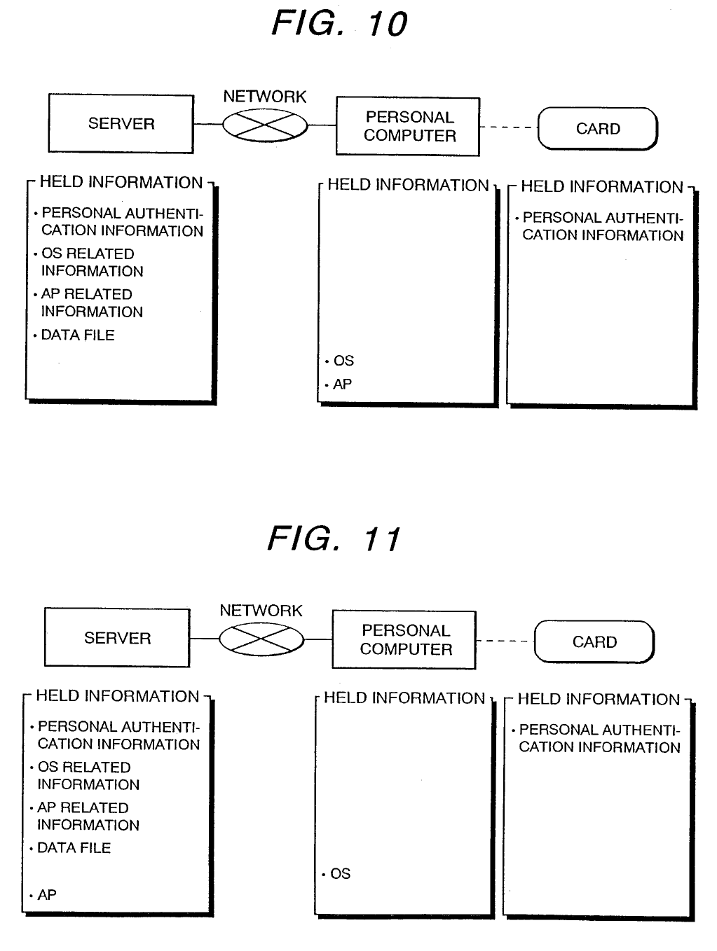

In the example shown in FIG. 10, the OS related information, the AP related information, and the data file are held in the server and the OS and the AP are held in the PC. The example has advantages such that variation in the hardware can be absorbed at the OS level and the risk of loosing the data file can be avoided. In the example, the AP which can process the data file in the IC card has to exist on the PC.

In the example shown in FIG. 11, the OS related information, the AP related information, the AP, and the data file are held in the server and only the OS is held in the PC. Although the example has an advantage that the AP does not have to be installed on the PC, there are problems such that it takes time to set the work environment since the AP is downloaded from the server, and when the version of the OS is different, the operation of the AP is not guaranteed.

Although the examples explained with reference to FIGS. 7 to 11 have the advantages and disadvantages, in each of the examples, only by setting the IC card to the PC, the PC can be set in the environment at the end of the previous work.

According to the invention as mentioned above, in the PC which is connected to the network and is used, when the PC or another PC is used to perform a work and the work is interrupted halfway at the previous time, the work environment at the interruption time point can be automatically set at the time of next start-up of the PC. At the times of ending and interruption of the work, the work environment at that time point can be held without performing the procedure for finishing the work.

What is claimed is:

1. A personal working environment setting system comprising:
a server which stores information containing personal authentication information and applications;
a plurality of processing units which are interconnected to said server via a network; and
input means for entering personal authentication information and server location information indicating a location of said server from an Integrated Circuit (IC) card to any one of said processing units,
wherein said one processing unit establishes a communication with said server according to personal authentication information and server location information entered from said input means and personal authentication information stored in said server,
wherein said one processing unit can use said applications stored in said server to carry out jobs,
wherein, when a job of said processing unit is suspended, working environmental information containing an operating status of an application in progress is stored in said server, and
wherein, when communication between said one processing unit and said server is re-established, said one processing unit downloads said working environmental information and said application in progress from said server to recover a previous working environment in said one processing unit.
